(19) United States
(12) Patent Application Publication
(10) Pub. No.: US 2024/0186544 A1
(43) Pub. Date: Jun. 6, 2024

(54) DEVICE FOR RECIRCULATING ANODE GAS IN AN ANODE CIRCUIT OF A FUEL CELL SYSTEM, AND FUEL CELL SYSTEM

(71) Applicant: Robert Bosch GmbH, Stuttgart (DE)

(72) Inventor: Hans-Christoph Magel, Reutlingen (DE)

(21) Appl. No.: 18/552,996

(22) PCT Filed: Mar. 15, 2022
(86) PCT No.: PCT/EP2022/056737

§ 371 Date: Sep. 28, 2023

(30) Foreign Application Priority Data
Apr. 8, 2021 (DE) 10 2021 203 454.3

(51) Int. Cl. H01M 8/04082; H01M 8/04089; H01M 8/04111

(52) U.S. Cl. CPC H01M 8/04201; H01M 8/04097; H01M 8/04111

(57) ABSTRACT

Disclosed is a device (1) for recirculating anode gas in an anode circuit (11) of a fuel cell system (10), comprising at least one jet pump (2) with a propelling nozzle (3) for introducing fresh anode gas, preferably hydrogen, an inlet (4) for recirculated anode gas, and an outlet (5) for fresh and recirculated anode gas; an actively controllable valve (6) for closing and opening the inlet (4) is arranged in the area of the inlet (4), said valve comprising a magnet assembly (7) for acting on a reciprocating armature (8), and a valve spring (9).

Also disclosed is a fuel cell system (10) comprising a device (1) of said kind.

### BACKGROUND

The invention relates to a device for recirculating anode gas in an anode circuit of a fuel cell system. Further proposed is a fuel cell system comprising a device according to the invention.

A fuel cell converts hydrogen and oxygen into electrical energy. To this end, the hydrogen is supplied to an anode, and the oxygen is supplied to a cathode of the fuel cell. Given that anode gas exiting from a PEM fuel cell typically still contains unused hydrogen, it is recirculated and fed to the anode again. The recirculation process can in this case be achieved actively using a recirculation blower and/or passively using a jet pump.

The use of a jet pump can prove to be problematic because fresh hydrogen usually cannot be added without activating the recirculation process. The decreasing recirculation performance of the jet pump in the partial load range also poses a problem. To remedy this, a smaller second jet pump can be employed, which is designed for the partial load range and is arranged parallel to the first jet pump. If only one jet pump is activated, however, the discharge from the active jet pump can reverse in direction through the inactive jet pump, so the flow path of the latter must be blocked, e.g., using an integrated check valve. However, this creates a pressure drop that reduces the recirculation efficiency of the active jet pump.

The present invention is concerned with solving these problems. On the one hand, the addition of fresh hydrogen without activation of the recirculation process is intended to be enabled. On the other hand, given jet pumps connected in parallel, a return flow of anode gas through the respective inactive jet pump is intended to be prevented, specifically with minimal loss.

### SUMMARY

The device according to the disclosure is proposed in order to solve these problems. Further specified is a fuel cell system having a device according to the invention.

The device proposed for recirculating anode gas in anode circuit of a fuel cell system comprises at least one jet pump with a propelling nozzle for introducing fresh anode gas, preferably hydrogen, an inlet for recirculated anode gas, and an outlet for fresh and recirculated anode gas. An actively controllable valve is in this case arranged in the area of the inlet in order to close and open the inlet. The valve comprises a magnet assembly for acting on a reciprocating armature and a valve spring.

Using the actively controllable valve, the inlet can be closed or blocked so that no anode gas is recirculated via the anode circuit. Fresh hydrogen can in this way be introduced into the anode circuit via the jet pump without recirculation, e.g., in order to run the anode circuit dry. If the device comprises several parallel connected jet pumps, then a jet pump can be intentionally deactivated using the actively controllable valve in order to prevent a return flow of anode gas through the inactive jet pump.

The actively controllable valve can be designed as a simple and inexpensive switching valve that closes or opens the inlet. This is possible because no absolute tightness of the valve is required to switch off the recirculation, nor can any outward leakage occur.

The magnet assembly of the actively controllable valve can be a simple linear magnetic actuator. Given that only low differential pressures occur in the anode circuit, only a low actuator force is required, so the magnet assembly can be designed to be correspondingly small.

The magnet assembly of the valve is preferably outside of a hydrogen-conducting area of the device. Effective sealing of the hydrogen-conducting area can be achieved in this way, and possible sources of ignition in the hydrogen-conducting area are also avoided.

It is alternatively or additionally proposed that the direction of action of the magnet assembly be perpendicular to the main flow direction in the inlet. In other words, the magnetic force generated by means of the magnet assembly acts on the reciprocating armature such that the latter reciprocates perpendicular to the main flow direction in the inlet. The inlet can in this way be closed and opened by simply moving the reciprocating armature back and forth.

To close and open the inlet, the reciprocating armature is preferably coupled to a valve closing element. The reciprocating armature and the valve closing element can thus be manufactured from different materials. It is alternatively proposed that the reciprocating armature simultaneously form a valve closing element. The actively controllable valve can in this way be manufactured in an even simpler and more cost-effective manner. To close the inlet, the valve closing element is preferably engageable with a lateral opening of the inlet. In other words, when the valve closes, the valve closing element is not only brought adjacent a wall surface bordering the inlet; it also engages with an opening in the wall surface. The tightness of the valve can be improved in this way.

In one further development of the invention, it is proposed that the reciprocating armature be interspersed in the axial direction by at least one pressure compensation opening. This is particularly advantageous when the reciprocating armature or the valve closing element engages into a lateral opening of the inlet upon closing. Since the orifice is filled with anode gas, it is thus avoided that the valve need be closed against the pressure building up in the orifice.

It is further proposed that at least sections of the reciprocating armature be sleeve-shaped in order to receive the valve spring. The actively controllable valve can as a result be designed to be very compact, particularly in the axial direction. At the same time, the mass of the reciprocating armature is reduced.

According to a preferred embodiment of the invention, the magnet assembly comprises a magnetic coil surrounded by an external pole body, into which coil a pot- or sleeve-shaped separating element made of a non-magnetic material is inserted, via which element the reciprocating armature is guided. The external pole body increases the magnetic force of the magnetic coil. At the same time, said body protects the magnetic coil from external influences. The pot- or sleeve-shaped separating element inserted into the magnetic coil prevents a magnetic short circuit between the reciprocating armature and the magnet assembly when the reciprocating armature is being guided. In addition, the hydrogen-conducting area can be sealed against the magnet assembly by means of the separating element.

Advantageously, the pot- or sleeve-shaped separating element is supported via an annular collar on an outer housing wall surface of the device, directly or indirectly via a sealing element. The separating element can in this way simultaneously be inserted in order to outwardly seal the hydrogen-conducting area. The sealing effect can be optimized by placing a sealing element, in particular a sealing ring, between the separating element and the outer housing wall surface. The separating element can further be easily attached to the outer wall surface of the housing via the annular collar.

The inlet in which the actively controllable valve is arranged preferably opens into a suction chamber of the jet pump, wherein the propelling nozzle is arranged inside the suction chamber. Using the propelling nozzle, a propellant force can be produced that causes recirculation of anode gas. However, if the inlet is closed using the actively controllable valve, the recirculation process can be switched off intentionally. The suction chamber is preferably connected to the jet pump outlet via a mixing tube and a diffuser. Recirculated and fresh anode gas meet in the suction chamber. The mixing of recirculated and fresh anode gas takes place in the subsequent mixing tube. In order to be able to arrange the driven nozzle coaxially with the mixing tube and diffuser, the inlet for recirculated anode gas preferably opens laterally into the suction chamber.

To enable the use of fresh anode gas as the propellant medium, a control valve can be upstream of the propellant nozzle. Alternatively, the propelling nozzle can be integrated into a dosing valve for fresh anode gas so that a particularly compact structural arrangement with few components is created.

Advantageously, the device comprises at least two jet pumps, which are connected in parallel and can be activated depending on the load. Sufficient recirculation power can in this way also be ensured within the partial load range. At the same time, discharge from the active jet pump reversing direction through the inactive jet pump during operation of only one jet pump can be prevented by means of the actively controllable valve arranged in the inlet.

Given that the preferred scope of use is a fuel cell system, a fuel cell system having a device according to the present invention is further proposed. The device is in this case integrated into an anode circuit of the fuel cell system. Using said device, anode gas leaking out of at least one fuel cell can be recirculated so that fuel demand decreases. Recirculation can be switched off using the actively controllable valve arranged in the inlet of the jet pump. If recirculation is effected using several jet pumps connected in parallel, then at least one jet pump can be deactivated and a return flow of anode gas through this jet pump can be actively prevented.

### BRIEF DESCRIPTION OF THE DRAWINGS

Preferred embodiments of the invention are described in greater detail hereinafter with reference to the accompanying drawings. Shown are:

FIG. 1 a schematic longitudinal section through a first device according to the invention for recirculating anode gas in an operating state in which the inlet is closed,

FIG. 2 a schematic longitudinal section through the device of FIG. 1 in an operating state in which the inlet is opened,

FIG. 3 a schematic longitudinal section through a second device according to the invention for the recirculation of anode gas, and

FIG. 4 a schematic illustration of an anode circuit of a fuel cell system according to the invention.

### DETAILED DESCRIPTION

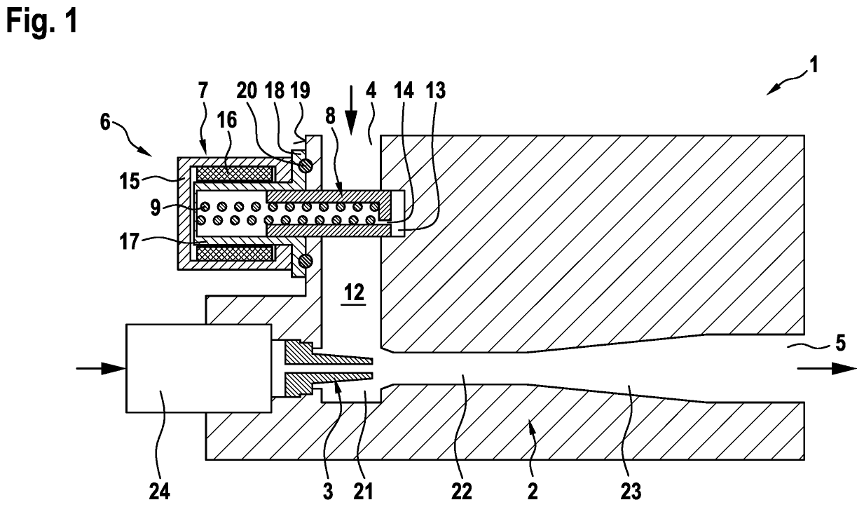

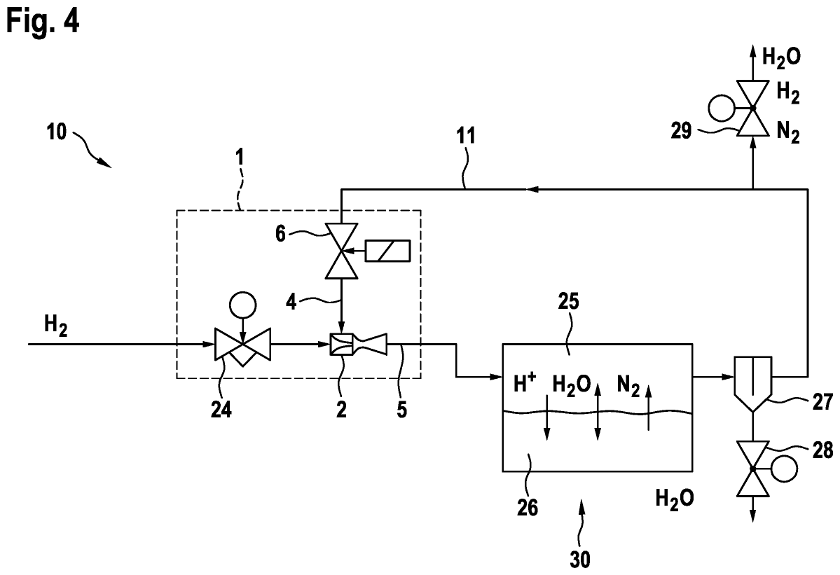

The device 1 according to the invention shown schematically in FIG. 1 is used to recirculate anode gas in an anode circuit 11 of a fuel cell system 10 (see FIG. 4). The device 1 comprises a jet pump 2 for this purpose, which is integrated or integrable into the anode circuit 11 via an inlet 4 as well as an outlet 5. The jet pump 2 further comprises a propelling nozzle 3 having an upstream control valve 24, by means of which fresh anode gas can be introduced into a suction chamber 21 of the jet pump 2. The fresh anode gas is also used as a propellant medium because, when introducing fresh anode gas using the propelling nozzle, a propellant force is generated that leads to the recirculation of anode gas in the anode circuit 11. The recirculated anode gas is introduced into the suction chamber 21 via the inlet 4. The inlet 4 opens laterally into the suction chamber 21, whereas the driven nozzle 3 is arranged coaxially with respect to a mixing tube 22 and a diffuser 23 of the jet pump 2.

An actively controllable valve 6 is integrated into the inlet 4, which valve comprises a magnet assembly 7 for acting on a movable reciprocating armature 8. In the present case, the valve 6 is designed as a valve which is closed when deenergized, (i.e., when the magnet assembly 7 is unpowered, the valve 6 is closed). In this switch position, the inlet 4 is also closed, so the recirculation is switched off. The closing force is generated using a valve spring 9 which is supported on the reciprocating armature 8.

The magnet assembly 7 of the valve 6 is arranged in an external position, i.e., outside of a hydrogen-conducting area 12, thus facilitating outward sealing of the hydrogen-conducting area 12. In addition, the formation of a possible ignition source in the hydrogen-conducting area 12 is avoided. The magnet assembly 7 comprises an external pole body 15 which receives a magnetic coil 16. A pot-shaped separating element 17 is inserted into the magnetic coil 16, which element is made of a non-magnetic material. The pot-shaped separating element 17 is used to guide the reciprocating armature 8 and, at the same time, prevent a magnetic short circuit between the reciprocating armature 8 and the magnet assembly 7. The separating element 17 also performs a sealing function. On the one hand, said element separates the hydrogen-conducting area 12 from the magnet assembly 7. On the other hand, it outwardly seals the hydrogen-conducting area 12. The separating element 17 comprises an annular collar 18 for this purpose, via which it is supported on an outer housing wall surface 19 of the device 1. To increase the sealing effect, a sealing element 20 is inserted between the annular collar 18 and the outer housing wall surface 19.

In the present case, the reciprocating armature 8 of the actively controllable valve 6 simultaneously forms a valve closing element which, in the closed position, engages into a lateral opening 13 of a wall bordering the inlet. The reciprocating armature 8 comprises a pressure compensation opening 14 in order to prevent the formation of a pressure buffer impeding the movements of the magnetic armature 8 within the opening 13. The reciprocating armature 8 is substantially sleeve-shaped so that it can receive the valve spring 9. The other end of the valve spring 9 is supported on the pot-shaped separating element 17.

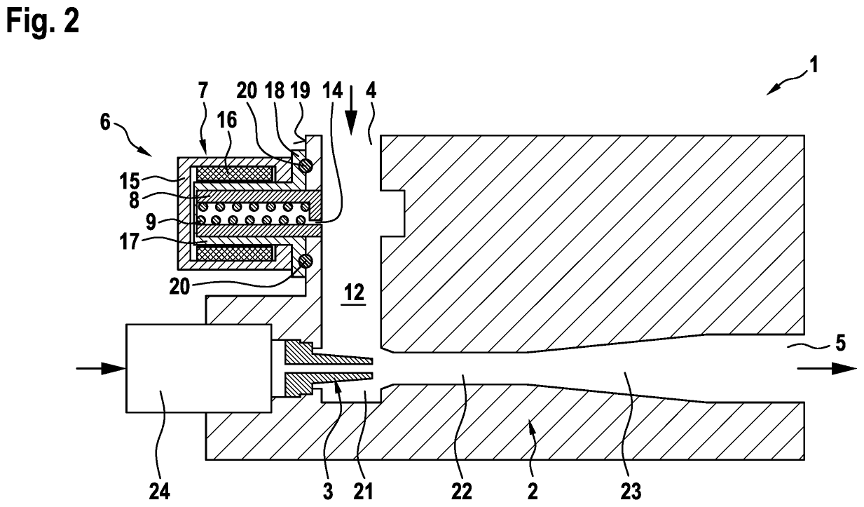

When the magnetic coil 16 of the magnet assembly 7 is energized, a magnetic field is formed, the magnetic force of which moves the reciprocating armature 8 towards the magnetic coil 16. This leads to the opening of the valve 6 so that the inlet 4 is opened. Anode gas can be recirculated when the valve 6 is switched to this position (see FIG. 2). To switch off recirculation, the valve 6 must be closed. For this purpose, energizing of the magnetic coil 16 ceases, so the valve spring 9 resets the reciprocating armature 8 to its initial position (FIG. 1).

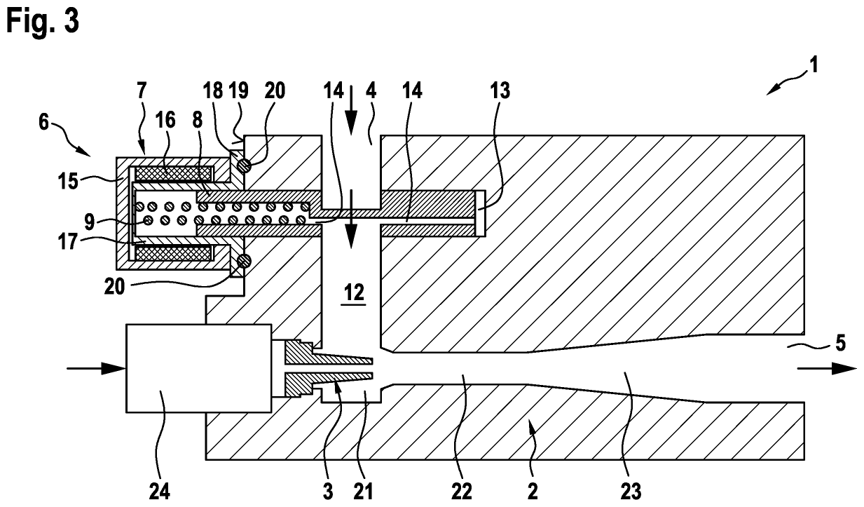

FIG. 3 shows a further device 1 according to the invention for recirculating anode gas. The latter differs from FIGS. 1 and 2 only in the design of the valve 6. In FIG. 3, the valve 6 is not designed as a valve which is closed when de-energized, but rather one which is open when de-energized. The reciprocating armature 8 has a somewhat different shape for this purpose. The valve 6 can otherwise be designed in a manner similar to the valve 6 shown in FIGS. 1 and 2.

The devices 1 according to the invention shown by way of example in FIGS. 1 to 3 are used in particular in an anode circuit 11 of a fuel cell system 10. This is shown schematically in FIG. 4.

The illustrated anode circuit 11 comprises an anode 25 of a fuel cell 30, which converts hydrogen together with oxygen into electrical energy. Air is used as the oxygen delivery agent and is supplied to a cathode 26 of the fuel cell 30 via a cathode path (not further shown in FIG. 4).

Fresh hydrogen (H₂) is introduced into the anode circuit 11 via a control valve 24 and a jet pump 2. The control valve 24 and the jet pump 2 form a device 1 for recirculating anode gas. Fresh as well as recirculated anode gas is accordingly mixed in the jet pump 2. Given that recirculated anode gas accumulates with nitrogen (N₂) over time and diffuses from the cathode side to the anode side, the anode circuit must be purged from time to time. A purge valve 29 is integrated into the anode circuit 11 for this purpose. Arranged upstream of the purge valve 29 are a water separator 27 and a drain valve 28, which can be used to remove product water (H₂O) from the anode circuit 11 during operation of the fuel cell system 10.

The device 1 for recirculating anode gas is connected to the anode circuit 11 via an inlet 4 and an outlet 5. An actively controllable valve 6 is in this case integrated into the inlet 4. Depending on the switch position of the valve 6, the inlet 4 is opened or closed. Fresh anode gas can in this way also be introduced via the jet pump 2 without recirculating the anode gas. The recirculation process can as a result be switched off by means of the actively controllable valve 6.

1. A device (1) for recirculating anode gas in an anode circuit (11) of a fuel cell system (10), said device comprising at least one jet pump (2) with a propelling nozzle (3) for introducing fresh anode gas, an inlet (4) for recirculated anode gas, and an outlet (5) for fresh and recirculated anode gas, wherein an actively controllable valve (6) for closing and opening the inlet (4) is arranged in an area of the inlet (4), said valve comprising a magnet assembly (7) for acting on a reciprocating armature (8), and a valve spring (9).

2. The device (1) according to claim 1,
wherein the magnet assembly (7) of the valve (6) is arranged outside of a hydrogen-conducting area (12) of the device (1), and/or a direction of action of the magnet assembly (7) is perpendicular to a main flow direction in the inlet (4).

3. The device (1) according to claim 1,
wherein the reciprocating armature (8) is coupled to a valve closing element or forms a valve closing element.

4. The device (1) according to claim 1,
wherein the reciprocating armature (8) is interspersed in an axial direction by at least one pressure compensation opening (14).

5. The device (1) according to claim 1,
wherein the reciprocating armature (8) is at least partially sleeve-shaped in order to receive the valve spring (9).

6. The device (1) according to claim 1,
wherein the magnet assembly (7) comprises a magnetic coil (16) surrounded by an outer pole body (15), into which coil a pot- or sleeve-shaped separating element (17) made of a non-magnetic material is inserted, via which element the reciprocating armature (8) is guided.

7. The device (1) according to claim 6,
wherein the pot- or sleeve-shaped separating element (17) is supported via an annular collar (18) on an outer housing wall surface (19) of the device (1) directly or indirectly via a sealing element (20).

8. The device (1) according to claim 1,
wherein the inlet (4) opens into a suction chamber (21) of the jet pump (2), wherein the jet nozzle (3) is arranged inside the suction chamber (21), and/or wherein the suction chamber (21) is connected to the outlet (5) via a mixing tube (22) and a diffuser (23).

9. The device (1) according to claim 1,
wherein the propelling nozzle (3) is downstream of a control valve (24) for metering fresh anode gas, or the propelling nozzle (3) is integrated into a metering valve for fresh anode gas.

10. The device (1) according to claim 1,
wherein at least two jet pumps (2) are connected in parallel and can be activated depending on a load.

11. A fuel cell system (10) having a device (1) according to claim 1, wherein the device (1) is integrated into an anode circuit (11) of the fuel cell system (10).

12. The device (1) according to claim 1, wherein the fresh anode gas is hydrogen.

13. The device (1) according to claim 3, wherein the valve closing element is engageable with a lateral opening (13) of the inlet (4) in order to close the inlet (4).
